(19) United States
(12) Patent Application Publication
(10) Pub. No.: US 2011/0197714 A1
(43) Pub. Date: Aug. 18, 2011

(54) MULTI-WRENCH APPARATUS AND METHOD OF USE

(76) Inventor: David Meholovitch, Glendora, CA (US)

(21) Appl. No.: 12/705,814

(22) Filed: Feb. 15, 2010

(51) Int. Cl. B25B 23/00; B25B 13/06

(52) U.S. Cl. 81/57.5; 81/124.5; 81/125.1

(57) ABSTRACT

A wrench assembly and a method of use are disclosed herein. A wrench assembly for handling one or more work pieces may include a handle, a first drive member connected to a first end of the handle, and a second drive member connected to a second end of the handle. The first and second drive members may each have a plurality of drives configured to engage and transmit torque to one or more work pieces. The drive members may include a spline configuration operable to engage work pieces having different shapes of engagement surfaces. A method of handling a work piece using the wrench assembly may include engaging one or more of the work pieces with the spline configuration of the drive members and transmitting torque to the work piece by applying a force to the wrench assembly.

### BACKGROUND OF THE INVENTION

1. Field of the Invention

Embodiments of the invention include a wrench assembly configured to engage and transfer torque to work pieces of various shapes and sizes. Embodiments of the invention include a wrench assembly having rotatable and replaceable drive members for selectively engaging work pieces of various shapes and sizes. Embodiments of the invention include a wrench assembly having a splined socket configuration that is operable to engage work pieces having different shaped and sized engagement surfaces.

2. Description of the Related Art

Numerous tools have been developed in the past to rotatably drive work pieces, such as bolts, nuts, and the like, in different types of work environments. Common wrenches, adjustable wrenches, and socket wrenches are just a few examples of the tools used to handle work pieces. These wrenches help provide the mechanical advantage necessary to form or remove a connection using a work piece. In a typical work environment, a person may need to handle numerous work pieces of different shapes and sizes, including damaged work pieces, to form or remove various connections. It may thus be necessary to have multiple tools available to work with these work piece connections, which increases the amount of equipment required to complete a job. In addition to the variety of work pieces, the physical work location may be confined to a small working area and/or the work pieces may be located in a confined space. It may thus be further necessary to have more tools available to handle the work pieces within these spatial limitations. Having several tools in a small work environment may cause disorganization, and having to search for a specific tool to handle each work piece can be extremely time-consuming.

Therefore, there is a need for a universal apparatus that is configured to handle various types, shapes, and sizes of work pieces, which thereby reduces the need to have multiple tools and pieces of equipment to handle the same work pieces effectively. There is a further need for an apparatus that can be used easily in confined spaces and configured to engage various types, shapes, and sizes of work pieces in confined spaces. There is a further need still for an improved apparatus that is durable, compact, easy to use, and provides the flexibility and versatility to handle assorted work pieces in any type of work environment.

### SUMMARY OF THE INVENTION

Embodiments of the invention include a wrench assembly and a method of use. In one embodiment, a wrench assembly for handling one or more work pieces may include a handle, a first drive member connected to a first end of the handle, and a second drive member connected to a second end of the handle. The first and second drive members may each have a plurality of drives configured to engage and transmit torque to one or more work pieces.

In one embodiment, a wrench assembly for transferring torque to one or more work pieces may include a handle and a first drive member connected to the handle. The first drive member may include a spline configuration operable to engage work pieces having different shapes of engagement surfaces.

In one embodiment, a method of handling a work piece using a wrench assembly may include providing a wrench assembly having a first drive member with a spline configuration that is configured to engage work pieces having different shapes of engagement surfaces. The method may further include engaging one or more of the work pieces with the drive member and transmitting torque to the work piece by applying a force to the wrench assembly.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a wrench assembly according to one embodiment of the invention.

FIGS. 2A-2F illustrate a sectional view of a socket of the wrench assembly engaging one or more work pieces according to embodiments of the invention.

FIGS. 3A-3B illustrate the wrench assembly and sockets according to one embodiment of the invention.

FIGS. 4 and 5 illustrate the wrench assembly according to embodiments of the invention.

FIGS. 6 and 7 illustrate the wrench assembly sockets according to embodiments of the invention.

### DETAILED DESCRIPTION

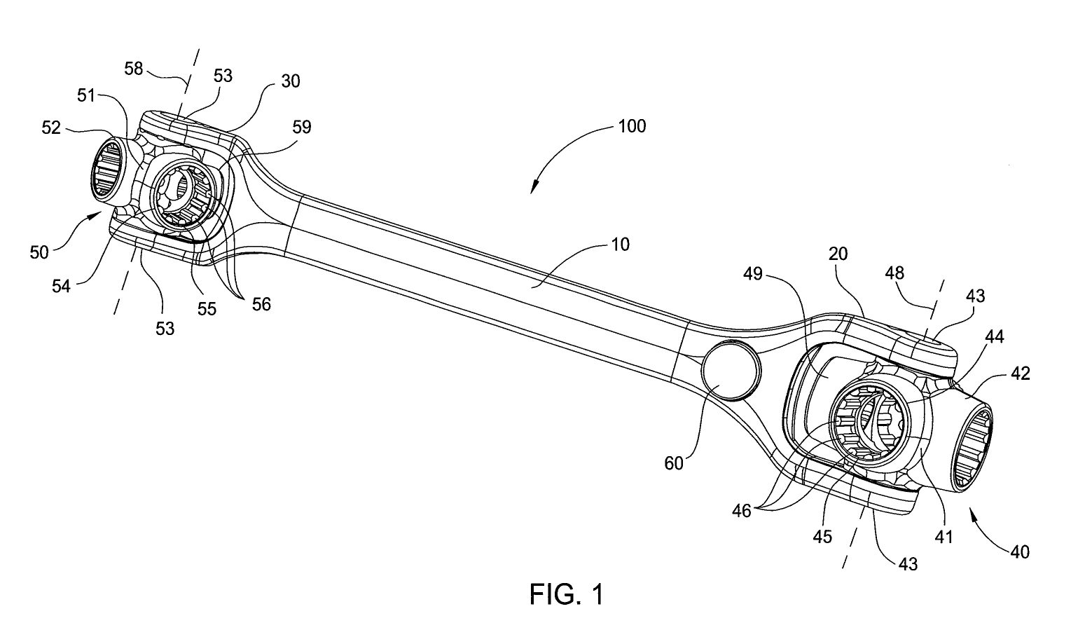

FIG. 1 illustrates a wrench assembly 100 according to one embodiment. The wrench assembly 100 is configured to engage multiple sizes and shapes of work pieces, such as bolts, nuts, screws, and the like. The wrench assembly 100 includes a handle 10, a first wrench end 20, a second wrench end 30, a first drive member 40, a second drive member 50, and an optional gripping mechanism 60. The components of the wrench assembly 100 may be formed from a variety of materials, including metal and metal alloys. In one embodiment, one or more components of the wrench assembly 100 may be formed from steel, such as chrome-moly steel.

The handle 10 includes a rectangular shaped body configured to be easily gripped by a user for handling of the wrench assembly 100. The first and second wrench ends 20 and 30 are located at opposite ends of the handle 10. The wrench ends 20 and 30 each include a pair of arms that extend from the handle 10, thereby forming a substantially “Y” or “U” shaped configuration. In one embodiment, the handle 10 and the wrench ends 20 and 30 may be formed from a single piece of material. In an alternative embodiment, the wrench ends 20 and 30 may be connected to the handle 10 in a number of ways know to one of ordinary skill, including a welded connection, a releasable connection, etc.

The wrench ends 20 and 30 are configured to support the first and second drive members 40 and 50, respectively. The drive members 40 and 50 are pivotably connected to the arms of each wrench end one or more pins 43 and 53 that extend through the sides of each arm and the drive members so that the drive members are rotatable relative to the handle 10. The drive members 40 and 50 may be connected to the wrench ends in a number of ways known to one of ordinary skill, including various bearing connections and/or releasable connections, etc. The drive members 40 and 50 may also be secured to the wrench ends 20 and 30 with a locking member, such as a pin and groove arrangement, which allows the drive members to be secured in a specific angular position relative to the handle 10. The locking member prevents uncontrolled rotation of the drive members 40 and 50 relative to the handle 10, such as by gravitational forces, and allows a controlled 360 degree positioning of the drive members during use of the wrenching assembly 100.

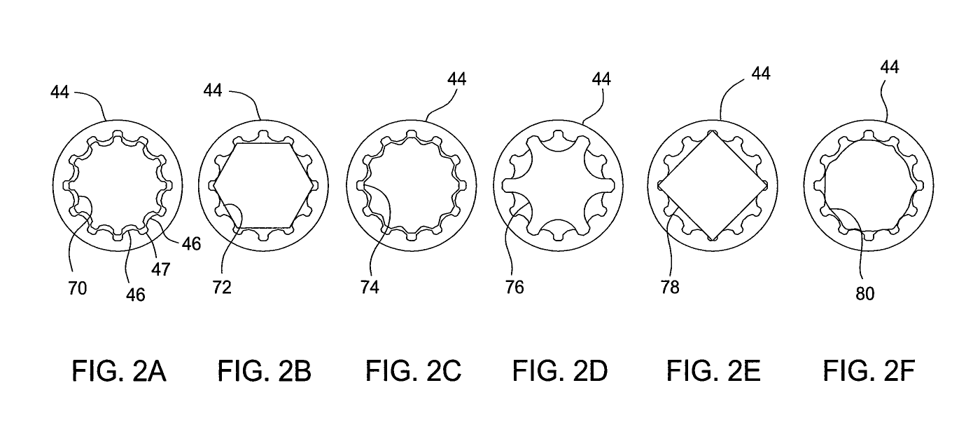

Although the following description recites features of the first drive member 40, the description similarly applies to the second drive member 50. Corresponding components of the second drive member have “50” series reference numerals. The first drive member 40 includes a body 41 having one or more sockets extending outward from the body. In one embodiment, the first drive member 40 includes four cylindrical shaped sockets that are symmetrically positioned about the body of the drive member. FIG. 1 illustrates three sockets 42, 44, and 49, with a fourth socket positioned on the opposite side of the body 41 from the socket 44, similar to the opposing sockets 42 and 49. The sockets may extend from the body at about a 90 degree angle from a central axis 48 of the body. Each socket has a central opening 45 so that opposing sockets, 42 and 49 for example, form a bore disposed through the body 41 of the first drive member 40. The sockets also include one or more splines 46 for engaging a work piece. As further illustrated in FIG. 2A, each spline 46 may be separated by a space, such as a groove 47, along the inner surface of the socket 44. In one embodiment, each socket includes twelve splines 46. In one embodiment, the splines 46 are symmetrically located around the central opening 45 of the socket and extend substantially the longitudinal length of each socket. In one embodiment, the ends of the splines 46 may be rounded or may have beveled edges to facilitate ease of insertion of the work piece into the socket. Each spline 46 may include a cylindrical shaped body, a rectangular shaped body having rounded edges, or any other shape configured to engage a workpiece and facilitate the transfer of torque to the work piece. In one embodiment, the body 41 of the drive member 40 and the splines 46 may be formed from a single piece of material. In one embodiment, splines 46, individually or as a group, may be secured to the inner surface of the body 41 of the drive member 40 in any manner known by one of ordinary skill, such as by weld, thread, etc. Various other socket configurations, splined or otherwise, may be used such that an individual socket is adapted to engage multiple shapes of work pieces and transfer torque thereto.

The splined configuration of each socket is adapted to engage multiple shapes of work pieces. FIGS. 2A-2F illustrate various work piece shapes that can be engaged using the splined configuration embodiment of the invention. FIGS. 2A-2F illustrates a cross-sectional view of the individual socket 44 of the first drive member 40 engaging several different work pieces 70, 72, 74, 76, 78, and 80. The socket 44 is configured to engage and transfer torque to the work pieces 70, 72, 74, 76, 78, and 80. In one embodiment, the work pieces shown in FIGS. 2A-2F may be bolts having a spline shaped bolt head, a 6-point bolt head, a 12-point bolt head, a star shaped bolt head, a square shaped bolt head, or a damaged or worn bolt head, respectively. In one embodiment, the work pieces shown in FIGS. 2A-2F may be nuts having the respective shapes described above.

In addition to the multiple shapes of work pieces that one socket may engage, the remaining sockets may each have a different diameter, thereby compounding the number, type, size, and shape of work pieces that the wrench assembly 100 may be used to handle. In one embodiment, one or more of the sockets may include a metric socket size of 8 mm, 10 mm, 11 mm, 13 mm, 14 mm, 16 mm, 17 mm, and 19 mm. In one embodiment, one or more of the sockets may include an SAE socket size of 5/16″, ⅜″, 7/16″, ½″, 9/16″, ⅝″, 11/16″, and ¾″. In one embodiment, the wrench assembly 100 may include other socket sizes known by one of ordinary skill. In one embodiment, the wrench assembly 100 may include the first drive member 40 having one or more splined sockets of varying diameters, and the second drive member 50 having one or more splined sockets of varying diameters that are greater than, less than, or equal to one or more of the sockets of the first drive member 40. The wrench assembly 100 and the wrench ends 20 and 30 may be adapted to support various combinations of socket sizes for each drive member.

The gripping mechanism 60 may be configured to hold one or more work pieces and/or secure the wrench assembly 100 to a work surface. In one embodiment, the gripping mechanism is a magnet. The magnet may hold one or more metallic work pieces, such as nuts, and/or secure the wrench assembly 100 to a metallic surface during non-use.

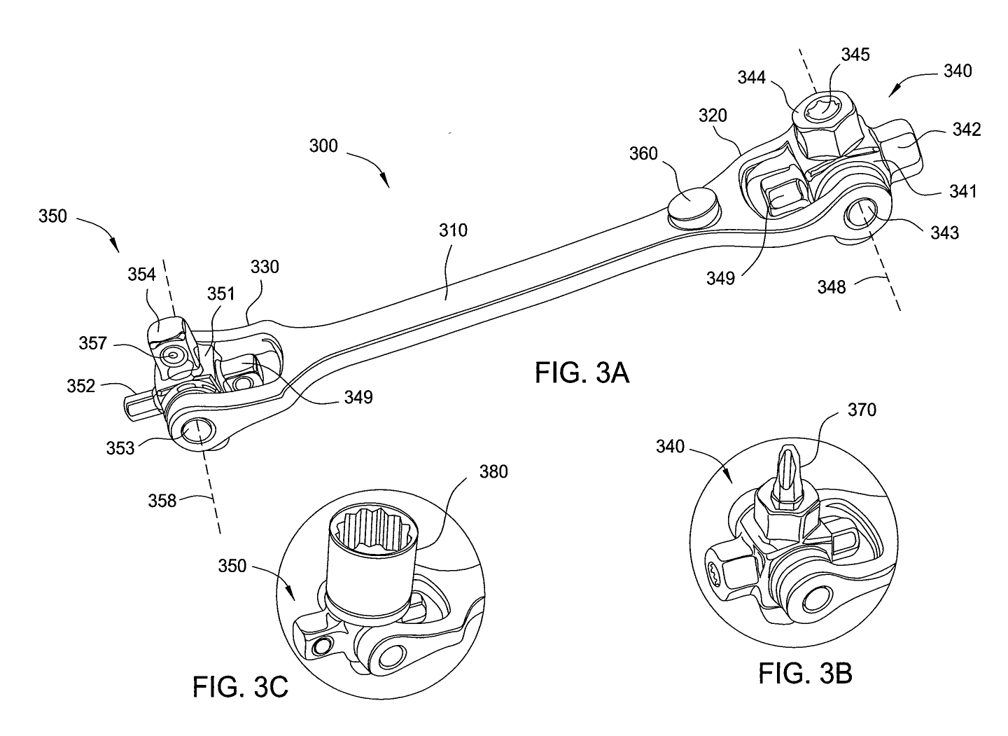

FIG. 3A illustrates a wrench assembly 300 according to one embodiment. The description of the wrench assembly 100 above similarly applies to the wrench assembly 300. Corresponding components of the wrench assembly 300 have “300” series reference numerals. The wrench assembly 300 includes a handle 310, a first wrench end 320, a second wrench end 330, a first drive member 340, a second drive member 350, and an optional gripping mechanism 360. The handle 310, the first and second wrench ends 320 and 330, the first and second drive members 340 and 350, and the gripping member 360 may be similarly configured relative to each other as the wrench assembly 100. The components of the wrench assembly 300 may be formed from a variety of materials, including metal and metal alloys. In one embodiment, one or more components of the wrench assembly 300 may be formed from steel, such as chrome-moly steel.

The first drive member 340 includes a body 341 having one or more bit drivers extending outward from the body. In one embodiment, the first drive member 340 includes four hexagonal and/or cylindrical shaped bit drivers that are symmetrically positioned about the body of the drive member. FIG. 3A illustrates three bit drivers 342, 344, and 349, with a fourth bit driver positioned on the opposite side of the body 341 from the bit driver 344, similar to the opposing bit drivers 342 and 349. The bit drivers may extend from the body at about a 90 degree angle from a central axis 348 of the body. Each bit driver has a central opening 345 adapted to receive one or more bits for engaging a work piece. In one embodiment, the central opening 345 includes a hexagonal shape and extends substantially the longitudinal length of the bit driver. In one embodiment, the edges of the central opening 345 may be rounded or may have beveled edges to facilitate ease of insertion of a bit into the bit driver. The bit driver may include any other shape configured to engage a workpiece with a bit and facilitate the transfer of torque to the work piece. Various other bit driver configurations may be used such that an individual bit driver is adapted to receive multiple sizes and shapes of bits and thus engage multiple sizes and shapes of work pieces.

The second drive member 350 includes a body 351 having one or more socket drivers extending outward from the body. In one embodiment, the second drive member 350 includes four square shaped socket drivers that are symmetrically positioned about the body of the drive member. FIG. 3A illustrates three socket drivers 352, 354, and 359, with a fourth socket driver positioned on the opposite side of the body 351 from the socket driver 354, similar to the opposing socket drivers 352 and 359. The socket drivers may extend from the body at about a 90 degree angle from a central axis 358 of the body. Each socket driver has a driving element 357 adapted to receive and temporarily secure one or more sockets for engaging a work piece. In one embodiment, the driving element 357 includes a square shaped arm that extends substantially the longitudinal length of the socket driver, and a spring loaded ball detent secured in the arm. In one embodiment, the edges of the driving element 357 may be rounded or may have beveled edges to facilitate ease of insertion of a socket onto the socket driver. The socket driver may include any other design configured to engage a workpiece with a socket and facilitate the transfer of torque to the work piece. Various other socket driver configurations may be used such that an individual socket driver is adapted to receive multiple sizes and shapes of sockets and thus engage multiple sizes and shapes of work pieces.

FIGS. 3B and 3C illustrate the first and second drive members 340 and 350, respectively. FIG. 3B illustrates a bit 370 secured to a bit driver of the first drive member 340. FIG. 3C illustrates a socket 380 secured to a socket driver of the second drive member 350. In one embodiment, the socket 380 secured to the second drive member 350 may include the splined configuration of the wrench assembly 100 described above.

In addition to the multiple shapes of bits and sockets that one bit driver or socket driver may engage, the remaining bit or socket drivers may each have a different size and/or shape, thereby compounding the number, type, size, and shape of bits and sockets and thus work pieces that the wrench assembly 300 may be used to handle. In one embodiment, one or more of the bit drivers may be configured to receive and secure drive bit sizes/shapes including ¼″ and ⅜″ drive bits having 5 mm, 7 mm, 10 mm Slotted, #2 Phillips, #3 Phillips, T10 Torx, T20 Torx and 7 mm and 12 mm Hex Bits. In one embodiment, one or more of the socket drivers may be configured to receive and secure sockets having a metric socket size of 8 mm, 10 mm, 11 mm, 12 mm, 13 mm, 14 mm, 16 mm, 17 mm, and 19 mm, and/or an SAE socket size of 5/16″, ⅜″, 7/16″, ½″, 9/16″, ⅝″, 11/16″, and ¾″. In one embodiment, the wrench assembly 300 may be configured for use with other bits and sockets known by one of ordinary skill. In one embodiment, the wrench assembly 300 may include the first drive member 340 having one or more bit drivers of varying shapes and sizes, and the second drive member 350 having one or more socket drivers of varying shapes and sizes. In one embodiment, the first drive member 340 and/or the second drive member 350 may each include a combination of one or more bit drivers connected with one or more socket drivers. The wrench assembly 300 and the wrench ends 320 and 330 may be adapted to support various combinations of bit and socket drives for each drive member.

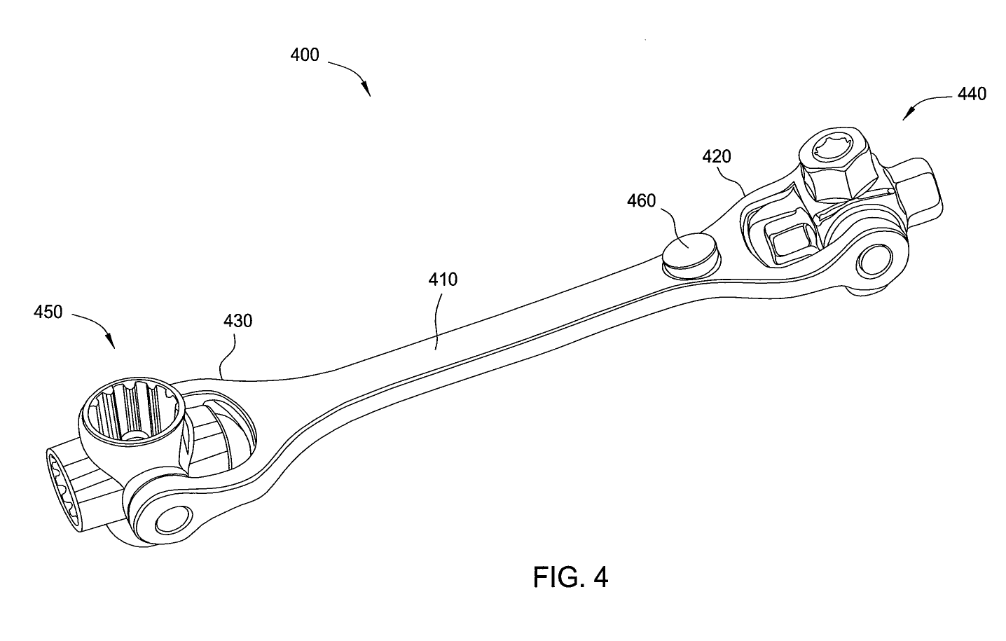

FIG. 4 illustrates a wrench assembly 400 according to one embodiment. The descriptions of the wrench assemblies 100 and 300 above similarly apply to the wrench assembly 400. Corresponding components of the wrench assembly 400 have “400” series reference numerals. The wrench assembly 400 includes a combination the wrench assemblies 100 and 300. As illustrated, the wrench assembly 400 includes a first drive member 440, which is the same component as the drive member 40 of the wrench assembly 100. The wrench assembly 400 also includes a second drive member 450, which is the same component as the drive member 340 of the wrench assembly 300. The wrench assembly 400 and the wrench ends 420 and 430 may be adapted to support various combinations of drive members described herein.

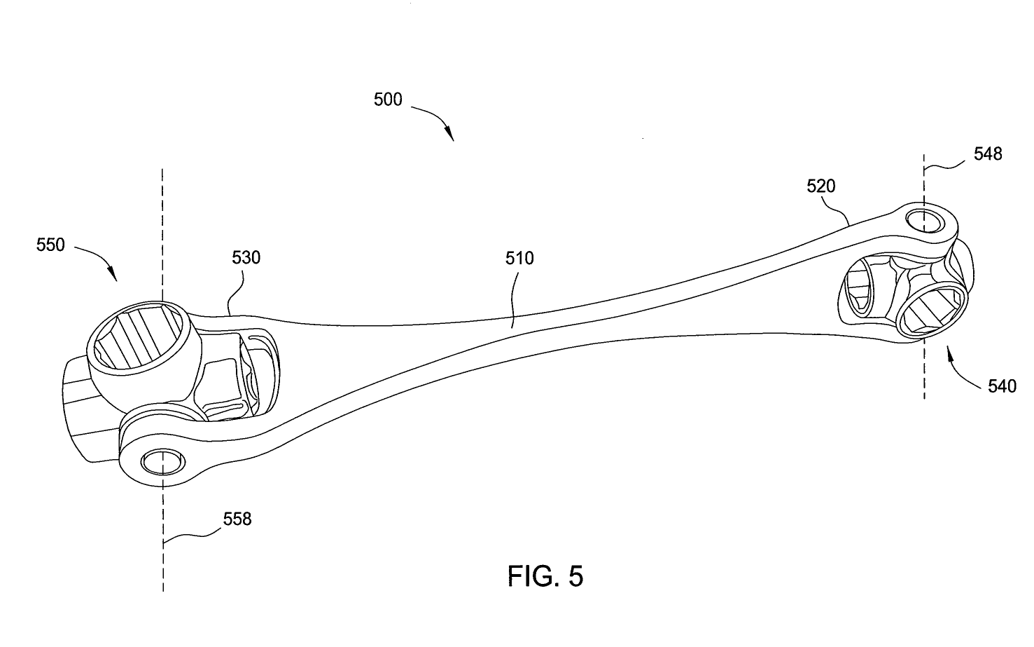

FIG. 5 illustrates a wrench assembly 500 according to one embodiment. The descriptions of the wrench assemblies 100, 300, and 400 above similarly apply to the wrench assembly 500. Corresponding components of the wrench assembly 500 have “500” series reference numerals. The wrench assembly 500 includes a handle 510, a first wrench end 520, a second wrench end 530, and first and second drive members 540 and 550. As illustrated, the wrench ends 520 and 530 are “twisted” relative to each other and extend from the handle 510 in opposite directions. The pair of arms of the first wrench end 520 are offset at an angle, a 90 degree angle for example, from the pair of arms of the second wrench end 530. In one embodiment, the transverse axis of the first wrench end 520 is located at a 90 degree angle relative to the transverse axis of the second wrench end 530. The handle 510 and the wrench ends 520 and 530 may be positioned relative to each other at various other angular configurations. The first and second drive members 540 and 550 may include one or more combinations of the drive members described herein. In one embodiment, the first and second drive members 540 and 550 each include four hexagonal sockets of varying diameters that are rotatably connected to the wrench ends.

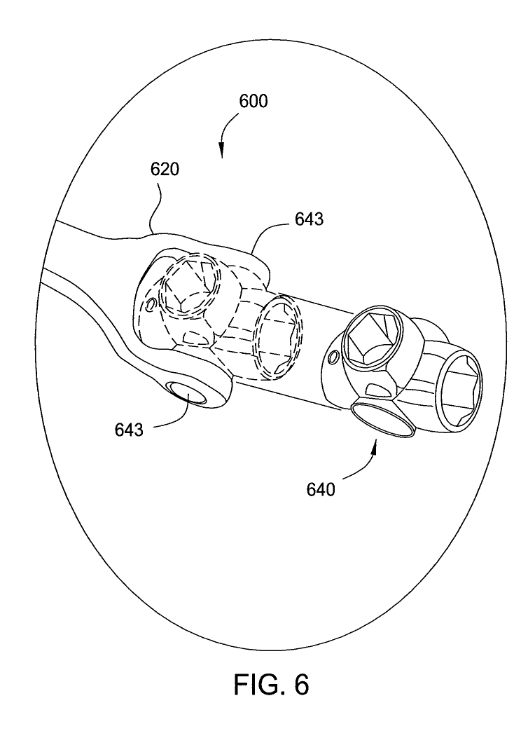

FIG. 6 illustrates a drive member 640 releaseably connected to a wrench end 620 of a wrench assembly 600. The descriptions of the wrench assemblies 100, 300, 400, and 500 above similarly apply to the wrench assembly 600. Corresponding components of the wrench assembly 600 have “600” series reference numerals. As illustrated, the drive member 640 may be released from the wrench end 620 by applying force to one or more of the pins 643 used to couple the drive member 640 to the wrench end 620. In one embodiment, the drive member 640 may be connected to and released from the wrench end 620 by a spring-loaded mechanism for quick connect and disconnect with the wrench assembly 600. Any type of connection known to one of ordinary skill may be used to releaseably connect the drive member 640 to the wrench end 620. In this manner, the wrench assembly 600 may be configured with changeable drive members on one or both of the wrench ends. The various drive members described herein may be releasably connected to any one of the wrench assemblies disclosed above.

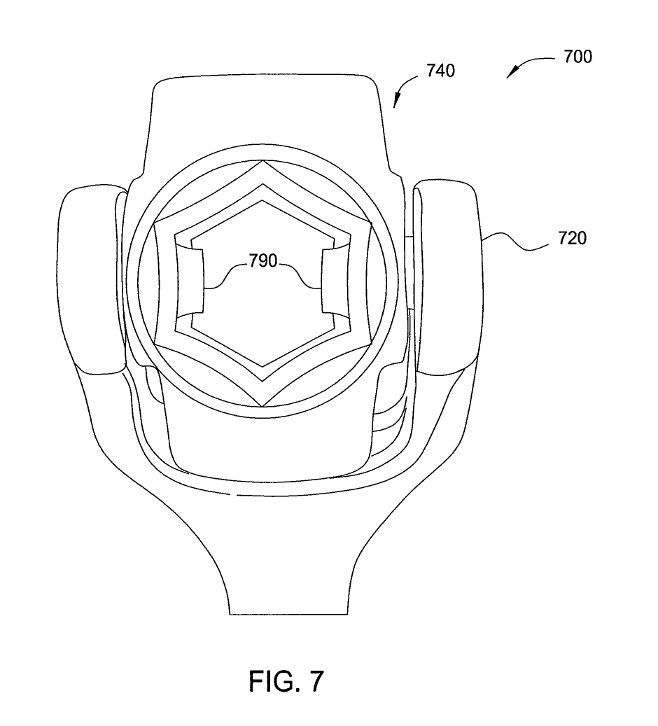

FIG. 7 illustrates a drive member 740 connected to a wrench end 720 of a wrench assembly 700. The descriptions of the wrench assemblies 100, 300, 400, 500, and 600 above similarly apply to the wrench assembly 700. Corresponding components of the wrench assembly 700 have “700” series reference numerals. As illustrated, the drive member 740 may include one or more gripping mechanisms 790 disposed on the inner surface of the bore of the drive member 740. In one embodiment, the gripping mechanism 790 may be a magnet configured to help secure the engagement between the wrench assembly 700 and the work piece being handled by the wrench assembly 700. Any type of gripping mechanism known to one of ordinary skill may be used to help secure connection between the wrench assembly and the work piece during use. The various drive members described herein may include similar gripping mechanisms, such as magnets, disposed on their inner surfaces to facilitate use of the wrench assemblies.

While the foregoing is directed to embodiments of the invention, other and further embodiments of the invention may be devised without departing from the basic scope thereof, and the scope thereof is determined by the claims that follow.

1. A wrench assembly for handling one or more work pieces, comprising:
a handle;
a first drive member connected to a first end of the handle; and
a second drive member connected to a second end of the handle, wherein the first and second drive members each have a plurality of drives configured to engage and transmit torque to one or more work pieces.

2. The assembly of claim 1, wherein at least one of the drives of the first or second drive members is a different size than one of the other drives of that drive member.

3. The assembly of claim 1, wherein the plurality of drives include sockets.

4. The assembly of claim 3, wherein the sockets include a plurality of splines disposed on an inner surface of the socket so that each individual socket is operable to engage work pieces having different shapes of engagement surfaces.

5. The assembly of claim 1, wherein the plurality of drives include socket drivers configured to receive and support sockets that are used for engagement with a work piece.

6. The assembly of claim 1, wherein the plurality of drives include bit drivers configured to receive and support bits that are used for engagement with a work piece.

7. The assembly of claim 1, wherein the plurality of drives of the first and second drive members include at least one of sockets, socket drivers, and bit drivers, and wherein the plurality of drives for the first drive member are different than the plurality of drives for the second drive member.

8. The assembly of claim 1, wherein at least one of the first and second drive members are rotatably relative to the first or second end of the handle.

9. The assembly of claim 1, wherein at least one of the first and second drive members are releasably connected to the first or second end of the handle.

10. The assembly of claim 1, wherein the first and second ends of the handle include a pair of arms configured to support the first and second drive members.

11. The assembly of claim 10, wherein the pair of arms of the first drive member are offset at an angle from the pair of arms of the second drive member.

12. The assembly of claim 11, wherein the angle is about a 90 degree angle such that a transverse axis of each pair of arms is perpendicular to the other pair of arms.

13. The assembly of claim 1, wherein at least one of the first and second drive members includes a gripping mechanism configured to secure an engagement between the first or second drive member and a work piece.

14. The assembly of claim 13, wherein the gripping mechanism is a magnet disposed on an inner surface of the first or second drive member.

15. A wrench assembly for transferring torque to one or more work pieces, comprising:
a handle;
a first drive member connected to the handle and having a spline configuration operable to engage work pieces having different shapes of engagement surfaces.

16. The assembly of claim 15, wherein the first drive member is a socket having the spline configuration, which includes a plurality of splines disposed on an inner surface of the socket.

17. The assembly of claim 15, wherein the first drive member includes a body and the spline configuration includes twelve splines symmetrically disposed on an inner surface of the body.

18. The assembly of claim 15, wherein the first drive member includes a body and a plurality of sockets extending from the body, wherein each socket includes a plurality of splines that form the spline configuration.

19. The assembly of claim 15, wherein the first drive member includes a body and at least two sockets extending from the body in opposite directions, wherein each socket includes a central opening and a plurality of splines disposed along the central opening that form the spline configuration, and wherein the central openings of each socket form a bore disposed through the body of the first drive member.

20. The assembly of claim 15, wherein the first drive member includes a body and a four sockets symmetrically extending from the body, wherein each socket includes a plurality of splines that form the spline configuration.

21. The assembly of claim 15, wherein the first drive member is at least one of rotatably and releasably connected to an end of the handle.

22. The assembly of claim 15, wherein the spline configuration is operable to engage work pieces including nuts or bolts with spline, 6-point, 12-point, torx, square, and worn shaped engagement surfaces.

23. A method of handling a work piece using a wrench assembly, comprising:
providing a wrench assembly having a first drive member with a spline configuration that is configured to engage work pieces having different shapes of engagement surfaces;
engaging one or more of the work pieces with the drive member; and
transmitting torque to the work piece by applying a force to the wrench assembly.

24. The method of claim 23, further comprising positioning one of a plurality of spline configurations of the first drive member for engagement with the work piece by rotating the drive member.

25. The method of claim 23, further comprising releasing the first drive member from a handle of the wrench assembly.
